(19) United States
(12) Patent Application Publication
(10) Pub. No.: US 2017/0327639 A1
(43) Pub. Date: Nov. 16, 2017

(54) POLYCARBONATE-POLYORGANOSILOXANE COPOLYMER PRODUCTION METHOD

(71) Applicant: IDEMITSU KOSAN CO., LTD., Tokyo (JP)

(72) Inventors: Kenji SASAKI, Ichihara-shi, Chiba (JP); Akihiro SHISHIKURA, Chiba-shi, Chiba (JP); Noriyuki KUNISHI, Ichihara-shi, Chiba (JP); Yukiko NAGAO, Koto-ku, Tokyo (JP)

(73) Assignee: IDEMITSU KOSAN CO., LTD., Tokyo (JP)

(21) Appl. No.: 15/532,945

(22) PCT Filed: Dec. 2, 2015
(86) PCT No.: PCT/JP2015/083937

§ 371 Date: Jun. 2, 2017

(30) Foreign Application Priority Data
Dec. 5, 2014 (JP) 2014-246858

(51) Int. Cl. C08G 64/08; C08G 64/40

(52) U.S. Cl. CPC C08G 64/085; C08G 64/406

(57) ABSTRACT

A method of producing a polycarbonate-polyorganosiloxane copolymer, including: a step (a) of obtaining a solution containing a polycarbonate-polyorganosiloxane copolymer through use of an alkaline aqueous solution of a dihydric phenol, phosgene, a polyorganosiloxane, and an organic solvent; a step (b) of continuously or intermittently draining the solution containing the copolymer from step (a), followed by separation of the drained solution into an aqueous phase and an organic phase to provide the organic phase with copolymer; and a step (c) of concentrating the organic phase with the from step (b) to remove the organic solvent, before heating the organic phase to a boiling region in the step (c), a viscosity of the organic phase being adjusted to 70 cP or less at 35° C., the polycarbonate-polyorganosiloxane copolymer obtained by the steps (a) to (c) including a polycarbonate-polyorganosiloxane copolymer containing a specific polycarbonate block (A) and a specific polyorganosiloxane block (B).

### TECHNICAL FIELD

The present invention relates to a method of producing a polycarbonate-polyorganosiloxane copolymer. More specifically, the present invention relates to a method of producing a polycarbonate-polyorganosiloxane copolymer with high production efficiency through an interfacial polycondensation method.

### BACKGROUND ART

A polycarbonate-based resin is a polymer excellent in transparency, heat resistance, and impact resistance and is widely used at present as an engineering plastic in the industrial field.

As a method of producing the polycarbonate-based resin, a method involving allowing an aromatic dihydroxy compound, such as bisphenol A, and phosgene to react directly with each other (interfacial polycondensation method) is known as a method of producing a high-quality polycarbonate.

The following method is generally adopted as an industrial production method for a polycarbonate based on the interfacial polycondensation method. A polycarbonate oligomer having a reactive chloroformate group is produced by blowing phosgene into an alkaline aqueous solution of a bisphenol. Further, the polycarbonate oligomer and the alkaline aqueous solution of the bisphenol are mixed, and a polycondensation reaction (polymerization reaction) is advanced in the presence of a polymerization catalyst, such as a tertiary amine.

Among the polycarbonate-based resins, a polycarbonate-polyorganosiloxane copolymer (hereinafter sometimes referred to as “PC-POS”) has been attracting attention because of its high impact resistance, high chemical resistance, and high flame retardancy, and the copolymer has been expected to find utilization in a wide variety of fields, such as the field of electrical and electronic equipment and the field of an automobile. As a method of producing the PC-POS, there is known a method (interfacial polycondensation reaction) involving allowing a dihydric phenol-based compound and phosgene to react with each other to produce a polycarbonate oligomer, and subjecting the polycarbonate oligomer and a polyorganosiloxane (hereinafter sometimes referred to as “POS”) to polycondensation in the presence of methylene chloride, an alkaline compound aqueous solution, a dihydric phenol-based compound, and a polymerization catalyst (see Patent Document 1).

### CITATION LIST

### Patent Document

Patent Document 1: JP 06-329781 A

### SUMMARY OF INVENTION

### Technical Problem

An organic solvent is removed from an organic phase containing a PC-POS obtained by the interfacial polycondensation method by heating concentration so that the concentration of the phase may fall within a range proper for powdering or granulation. A method for the heating concentration of the organic phase containing the PC-POS is, for example, a method involving heating the phase with a heat exchanger, such as a flash drum.

However, when the chain length of the PC-POS in the organic phase containing the PC-POS is as short as from about 25 to about 55, the heating of the organic phase to a boiling region involves the following problem. The organic phase causes peculiar bubbling owing to the evaporation of the organic solvent, and hence the heat transfer performance of the heat exchanger rapidly deteriorates to reduce productivity.

In view of the problem, an object of the present invention is to provide a method of producing a polycarbonate-polyorganosiloxane copolymer excellent in productivity.

### Solution to Problem

The inventors of the present invention have made extensive investigations, and as a result, have found a method of producing a polycarbonate-polyorganosiloxane copolymer excellent in productivity by controlling the viscosity of an organic phase containing a PC-POS produced by using a short-chain POS through an interfacial polycondensation method at the time of the heating of the organic phase containing the PC-POS to a boiling region with a heat exchanger. Thus, the inventors have completed the present invention.

That is, the present invention relates to the following items [1] to [9].

[1] A method of producing a polycarbonate-polyorganosiloxane copolymer, comprising:

a step (a) of obtaining a solution containing a polycarbonate-polyorganosiloxane copolymer through use of an alkaline aqueous solution of a dihydric phenol, phosgene, a polyorganosiloxane, and an organic solvent;

a step (b) of separating the solution containing the polycarbonate-polyorganosiloxane copolymer obtained in the step (a) into an aqueous phase and an organic phase to provide the organic phase containing the polycarbonate-polyorganosiloxane copolymer; and
a step (c) of concentrating the organic phase containing the polycarbonate-polyorganosiloxane copolymer obtained in the step (b) to remove the organic solvent,
before heating the organic phase to a boiling region in the step (c), a viscosity of the organic phase being adjusted to 70 cP or less at 35° C.,
the polycarbonate-polyorganosiloxane copolymer obtained by the steps (a) to (c) comprising a polycarbonate-polyorganosiloxane copolymer containing a polycarbonate block (A) containing a repeating unit represented by the following general formula (I) and a polyorganosiloxane block (B) containing a repeating unit represented by the following general formula (II):

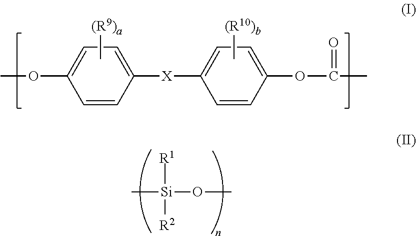

wherein R⁹ and R¹⁰ each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, a and b each independently represent an integer of from 0 to 4, R¹ and R² each independently represent a hydrogen atom, a halogen atom, an alkyl group having 1 to 6 carbon atoms, an alkoxy group having 1 to 6 carbon atoms, or an aryl group having 6 to 12 carbon atoms, and an average number n of repetitions is from 25 to 55, and represents a total number of siloxane repeating units in the polyorganosiloxane block.

[2] The method of producing a polycarbonate-polyorganosiloxane copolymer according to Item [1], wherein the dihydric phenol comprises a dihydric phenol represented by the following general formula (1):

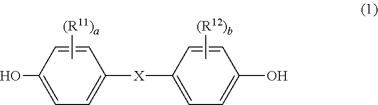

wherein R¹¹ and R¹² each independently represent an alkyl group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, —S—, —SO—, —SO₂—, —O—, or —CO—, and a and b each independently represent an integer of from 0 to 4.

[3] The method of producing a polycarbonate-polyorganosiloxane copolymer according to Item [1] or [2], wherein the polyorganosiloxane comprises a polyorganosiloxane represented by at least one selected from the following general formulae (2), (3), and (4):

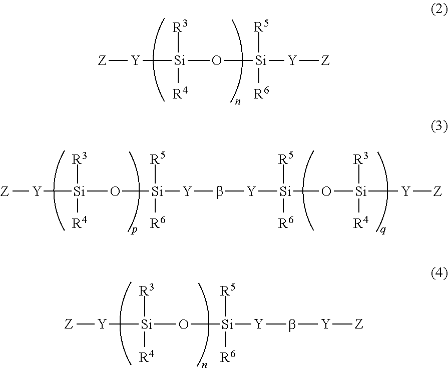

wherein R³ to R⁶ each independently represent a hydrogen atom, a halogen atom, an alkyl group having 1 to 6 carbon atoms, an alkoxy group having 1 to 6 carbon atoms, or an aryl group having 6 to 12 carbon atoms, and a plurality of R³, R⁴, R⁵ and/or R⁶ may be identical to or different from each other, Y represents —R⁷O—, —R⁷COO—, —R⁷NH—, —R⁷NR⁸—, —COO—, —S—, —R⁷COO—R⁹—O—, or —R⁷O—R¹⁰—O—, and a plurality of Y may be identical to or different from each other, the R⁷ represents a single bond, a linear, branched, or cyclic alkylene group, an aryl-substituted alkylene group, a substituted or unsubstituted arylene group, or a diarylene group, R⁸ represents an alkyl group, an alkenyl group, an aryl group, or an aralkyl group, R⁹ represents a diarylene group, R¹⁶ represents a linear, branched, or cyclic alkylene group, or a diarylene group, Z represents a hydrogen atom or a halogen atom, and a plurality of Z may be identical to or different from each other, β represents a divalent group derived from a diisocyanate compound, or a divalent group derived from a dicarboxylic acid or a halide of a dicarboxylic acid, p and q each represent an integer of 1 or more, and a sum of p and q is from 25 to 55, and n represents an average number of repetitions of from 25 to 55.

[4] The method of producing a polycarbonate-polyorganosiloxane copolymer according to any one of Items [1] to [3], wherein the dihydric phenol comprises bisphenol A.

[5] The method of producing a polycarbonate-polyorganosiloxane copolymer according to anyone of Items [1] to [4], wherein the organic phase comprises a methylene chloride solution containing the polycarbonate-polyorganosiloxane copolymer.

[6] The method of producing a polycarbonate-polyorganosiloxane copolymer according to Item [5], wherein the methylene chloride solution containing the polycarbonate-polyorganosiloxane copolymer has a polymer concentration of from 10 mass % to 30 mass %.

[7] The method of producing a polycarbonate-polyorganosiloxane copolymer according to any one of Items [1] to [6], wherein concentrating the organic phase is performed by heating the organic phase to from 40° C. to 150° C. under a pressure of from 0.2 MPa to 2.0 MPa.

[8] The method of producing a polycarbonate-polyorganosiloxane copolymer according to any one of Items [1] to [7], wherein a polyorganosiloxane content in the polycarbonate-polyorganosiloxane copolymer is from 1 mass % to 50 mass %.

[9] The method of producing a polycarbonate-polyorganosiloxane copolymer according to any one of Items [1] to [8], wherein the polycarbonate-polyorganosiloxane copolymer has a viscosity-average molecular weight of from 10,000 to 30,000.

### Advantageous Effects of Invention

According to the present invention, the method of producing a polycarbonate-polyorganosiloxane copolymer excellent in productivity can be provided.

### BRIEF DESCRIPTION OF DRAWINGS

FIG. 1 is a schematic view of a reaction process according to an embodiment of the present invention.

### DESCRIPTION OF EMBODIMENTS

A method of producing a polycarbonate-polyorganosiloxane copolymer of the present invention comprises:

a step (a) of obtaining a solution containing a polycarbonate-polyorganosiloxane copolymer through use of an alkaline aqueous solution of a dihydric phenol, phosgene, a polyorganosiloxane, and an organic solvent;

a step (b) of separating the solution containing the polycarbonate-polyorganosiloxane copolymer obtained in the step (a) into an aqueous phase and an organic phase to provide the organic phase containing the polycarbonate-polyorganosiloxane copolymer; and

a step (c) of concentrating the organic phase containing the polycarbonate-polyorganosiloxane copolymer obtained in the step (b) to remove the organic solvent,

when the organic phase is heated to a boiling region in the step (c), a viscosity of the organic phase being set to 70 cP or less at 35° C.,

the polycarbonate-polyorganosiloxane copolymer obtained by the steps (a) to (c) comprising a polycarbonate-polyorganosiloxane copolymer containing a polycarbonate block (A) containing a repeating unit represented by the following general formula (I) and a polyorganosiloxane block (B) containing a repeating unit represented by the following general formula (II):

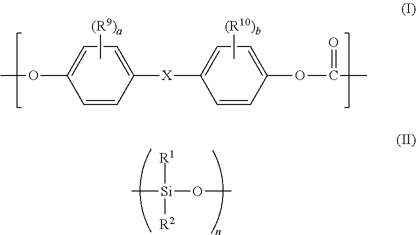

In the general formula (I) or the general formula (II), R⁹ and R¹⁰ each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, a and b each independently represent an integer of from 0 to 4, R¹ and R² each independently represent a hydrogen atom, a halogen atom, an alkyl group having 1 to 6 carbon atoms, an alkoxy group having 1 to 6 carbon atoms, or an aryl group having 6 to 12 carbon atoms, and an average number n of repetitions is from 25 to 55, and represents a total number of siloxane repeating units in the polyorganosiloxane block.

The method of producing a polycarbonate-polyorganosiloxane copolymer of the present invention is described in detail below. In this description, a specification considered to be preferred can be arbitrarily adopted, and a combination of preferred provisions is more preferred.

### [Polycarbonate Oligomer]

Although a method of producing a polycarbonate oligomer to be used in the method of producing a polycarbonate-polyorganosiloxane copolymer of the present invention is not particularly limited, for example, the following method can be preferably used.

First, an alkaline aqueous solution of a dihydric phenol is prepared. The solution and an organic solvent, such as methylene chloride, are mixed, and while the mixture is stirred, phosgene is subjected to a reaction in the presence of the alkaline aqueous solution containing the dihydric phenol and the organic solvent. Thus, the polycarbonate oligomer is obtained.

The dihydric phenol is preferably a dihydric phenol represented by the following general formula (1):

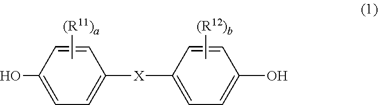

In the general formula (1), R¹¹ and R¹² each independently represent an alkyl group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, —S—, —SO—, —SO₂—, —O—, or —CO—, and a and b each independently represent an integer of from 0 to 4.

Although the dihydric phenol represented by the general formula (1) is not particularly limited, 2,2-bis(4-hydroxyphenyl) propane [trivial name: bisphenol A] is suitable.

Examples of the dihydric phenol other than bisphenol A include: bis(hydroxyaryl)alkanes, such as bis(4-hydroxyphenyl)methane, 1,1-bis(4-hydroxyphenyl)ethane, 2,2-bis(4-hydroxyphenyl)butane, 2,2-bis(4-hydroxyphenyl)octane, bis(4-hydroxyphenyl)phenylmethane, bis(4-hydroxyphenyl)diphenylmethane, 2,2-bis(4-hydroxy-3-methylphenyl)propane, bis(4-hydroxyphenyl)naphthylmethane, 1,1-bis(4-hydroxy-t-butylphenyl)propane, 2,2-bis(4-hydroxy-3-bromophenyl)propane, 2,2-bis(4-hydroxy-3,5-dimethylphenyl)propane, 2,2-bis(4-hydroxy-3-chlorophenyl)propane, 2,2-bis(4-hydroxy-3,5-dichlorophenyl)propane, and 2,2-bis(4-hydroxy-3,5-dibromophenyl)propane; bis(hydroxyaryl)cycloalkanes, such as 1,1-bis(4-hydroxyphenyl)cyclopentane, 1,1-bis(4-hydroxyphenyl)cyclohexane, 1,1-bis(4-hydroxyphenyl)-3,5,5-trimethylcyclohexane, 2,2-bis(4-hydroxyphenyl)norbornane, and 1,1-bis(4-hydroxyphenyl)cyclododecane; dihydroxyaryl ethers, such as 4,4′-dihydroxydiphenyl ether and 4,4′-dihydroxy-3,3′-dimethylphenyl ether; dihydroxydiaryl sulfides, such as 4,4′-dihydroxydiphenyl sulfide and 4,4′-dihydroxy-3,3′-dimethyldiphenyl sulfide; dihydroxydiarylsulfoxides, such as 4,4′-dihydroxydiphenyl sulfoxide and 4,4′-dihydroxy-3,3′-dimethyldiphenyl sulfoxide; dihydroxydiaryl sulfones, such as 4,4′-dihydroxydiphenyl sulfone and 4,4′-dihydroxy-3,3′-dimethyldiphenyl sulfone; dihydroxydiphenyls, such as 4,4′-dihydroxydiphenyl; dihydroxydiarylfluorenes, such as 9,9-bis(4-hydroxyphenyl)fluorene and 9,9-bis(4-hydroxy-3-methylphenyl)fluorene; dihydroxydiaryladamantanes, such as 1,3-bis(4-hydroxyphenyl)adamantane, 2,2-bis(4-hydroxyphenyl)adamantane, and 1,3-bis(4-hydroxyphenyl)-5,7-dimethyladamantane; 4,4′-[1,3-phenylenebis(1-methylethylidene)]bisphenol; 10,10-bis(4-hydroxyphenyl)-9-anthrone; and 1,5-bis(4-hydroxyphenylthio)-2,3-dioxapentane.

One of those dihydric phenols may be used alone, or two or more thereof may be used as a mixture.

The polyorganosiloxane is preferably a polyorganosiloxane represented by at least one selected from the following general formulae (2), (3), and (4).

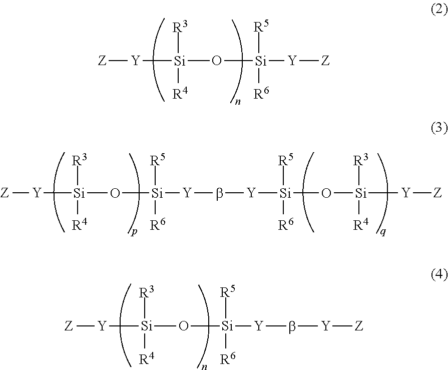

In the general formulae (2), (3), and (4), R³ to R⁶ each independently represent a hydrogen atom, a halogen atom, an alkyl group having 1 to 6 carbon atoms, an alkoxy group having 1 to 6 carbon atoms, or an aryl group having 6 to 12 carbon atoms, and a plurality of R³, R⁴, R⁵ and/or R⁶ may be identical to or different from each other, Y represents —R⁷O—, —R⁷COO—, —R⁷NH—, —R⁷NR⁸—, —COO—, —S—, —R⁷COO—R⁹—O—, or —R⁷O—R¹⁰—O—, and a plurality of Y may be identical to or different from each other, R⁷ represents a single bond, a linear, branched, or cyclic alkylene group, an aryl-substituted alkylene group, a substituted or unsubstituted arylene group, or a diarylene group, R⁸ represents an alkyl group, an alkenyl group, an aryl group, or an aralkyl group, R⁹ represents a diarylene group, R¹⁰ represents a linear, branched, or cyclic alkylene group, or a diarylene group, Z represents a hydrogen atom or a halogen atom, and a plurality of Z may be identical to or different from each other, β represents a divalent group derived from a diisocyanate compound, or a divalent group derived from a dicarboxylic acid or a halide of a dicarboxylic acid, p and q each represent an integer of 1 or more, and a sum of p and q is from 20 to 500, preferably from 25 to 55, and n represents an average number of repetitions of from 20 to 500, preferably from 25 to 55.

Examples of the halogen atom that R³ to R⁶ each independently represent include a fluorine atom, a chlorine atom, a bromine atom, and an iodine atom. Examples of the alkyl group that R³ to R⁶ each independently represent include a methyl group, an ethyl group, a n-propyl group, an isopropyl group, various butyl groups (“various” means that a linear group and any branched group are included, and the same applies hereinafter), various pentyl groups, and various hexyl groups. An example of the alkoxy group that R³ to R⁶ each independently represent is an alkoxy group whose alkyl group moiety is the alkyl group described above. Examples of the aryl group that R³ to R⁶ each independently represent include a phenyl group and a naphthyl group.

R³ to R⁶ each preferably represent a hydrogen atom, an alkyl group having 1 to 6 carbon atoms, an alkoxy group having 1 to 6 carbon atoms, or an aryl group having 6 to 12 carbon atoms.

The polyorganosiloxane represented by at least one selected from the general formulae (2), (3), and (4) is preferably a polyorganosiloxane in which R³ to R⁶ each represent a methyl group.

The linear or branched alkylene group represented by R⁷ in —R⁷O—, —R⁷COO—, —R⁷NH—, —R⁷NR⁸—, —COO—, —S—, —R⁷COO—R⁹—O—, or —R⁷O—R¹⁰—O— represented by Y is, for example, an alkylene group having 1 to 8 carbon atoms, preferably 1 to 5 carbon atoms, and the cyclic alkylene group represented by R⁷ is, for example, a cycloalkylene group having 5 to 15 carbon atoms, preferably 5 to 10 carbon atoms.

The aryl-substituted alkylene group represented by R⁷ may have a substituent, such as an alkoxy group or an alkyl group, on its aromatic ring, and its specific structure may be, for example, a structure represented by the following general formula (5) or (6). When the polyorganosiloxane has the aryl-substituted alkylene group, the alkylene group is bonded to Si:

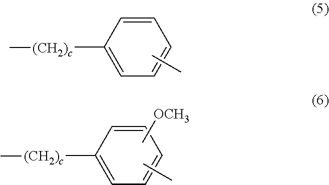

In the formulae (5) and (6), c represents a positive integer and typically represents an integer of from 1 to 6.

The diarylene group represented by each of R⁷, R⁹, and R¹⁰ refers to a group in which two arylene groups are linked to each other directly or through a divalent organic group, and is specifically a group having a structure represented by and —Ar¹—W—Ar²—. Ar¹ and Ar² each represent an arylene group, and W represents a single bond or a divalent organic group. Examples of the divalent organic group represented by W include an isopropylidene group, a methylene group, a dimethylene group, and a trimethylene group.

Examples of the arylene group represented by each of R⁷, Ar¹, and Ar² include arylene groups each having 6 to 14 ring-forming carbon atoms, such as a phenylene group, a naphthylene group, a biphenylene group, and an anthrylene group. Those arylene groups may each have an arbitrary substituent, such as an alkoxy group or an alkyl group.

The alkyl group represented by R⁸ is a linear or branched alkyl group having 1 to 8, preferably 1 to 5 carbon atoms. The alkenyl group represented by R⁸ is, for example, a linear or branched alkenyl group having 2 to 8, preferably 2 to 5 carbon atoms. The aryl group represented by R⁸ is, for example, a phenyl group or a naphthyl group. The aralkyl group represented by R⁸ is, for example, a phenylmethyl group or a phenylethyl group.

The linear, branched, or cyclic alkylene group represented by R¹⁰ is the same as that represented by R⁷.

Y preferably represents —R⁷O—, and R⁷ represents an aryl-substituted alkylene group, in particular a residue of a phenol-based compound having an alkyl group, and more preferably represents an organic residue derived from allylphenol or an organic residue derived from eugenol.

With regard to p and q in the general formula (3), it is preferred that p=q, i.e., p=n/2 and q=n/2.

The average number n of repetitions is from 20 to 500, preferably from 20 to 400, more preferably from 20 to 300, still more preferably from 25 to 55. When the n is 20 or more, the PC-POS can obtain excellent impact resistance, and significant restoration of the impact resistance can be achieved. When the n is 500 or less, handleability at the time of the production of the PC-POS is excellent. The number n of repeating units can be calculated by ¹H-NMR.

In addition, β represents a divalent group derived from a diisocyanate compound, or a divalent group derived from a dicarboxylic acid or a halide of a dicarboxylic acid, and examples thereof include divalent groups represented by the following general formulae (7-1) to (7-5).

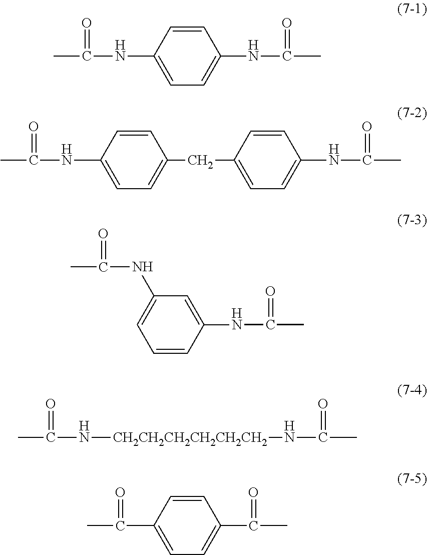

Examples of the polyorganosiloxane represented by the general formula (2) include compounds represented by the following general formulae (2-1) to (2-11):

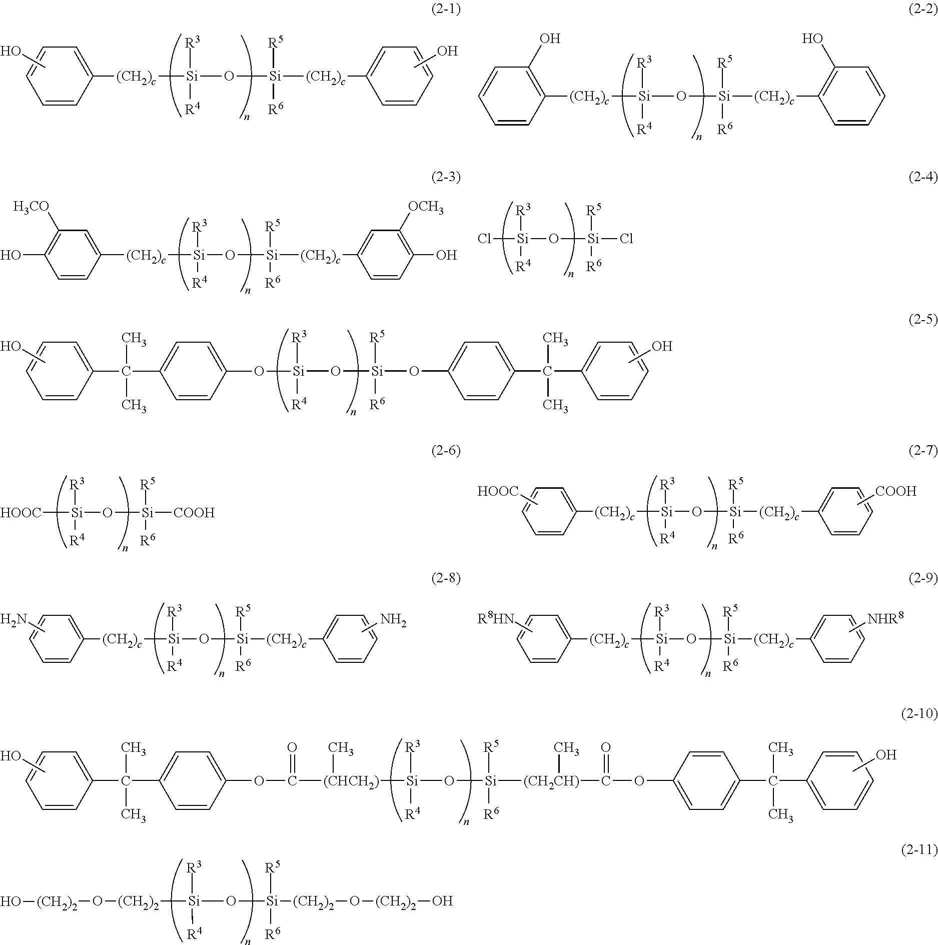

In the general formulae (2-1) to (2-11), R³ to R⁶, n, and R⁸ are as defined above, and preferred groups and values thereof are also the same, and c represents a positive integer and typically represents an integer of from 1 to 6.

Among them, a phenol-modified polyorganosiloxane represented by the general formula (2-1) is preferred from the viewpoint of the ease of polymerization. In addition, α,ω-bis[3-(o-hydroxyphenyl) propyl]polydimethylsiloxane as one of the compounds each represented by the general formula (2-2) or α,ω-bis[3-(4-hydroxy-3-methoxyphenyl)propyl]polydimethylsiloxane as one of the compounds each represented by the general formula (2-3) is preferred from the viewpoint of the ease of availability.

Further, a branching agent can be used to forma branched structure in the main chain of the polycarbonate resin. The addition amount of the branching agent is preferably from 0.01 mol % to 3.0 mol %, more preferably from 0.1 mol % to 1.0 mol % with respect to the dihydric phenol.

Examples of the branching agent include compounds each having 3 or more functional groups, such as 1,1,1-tris(4-hydroxyphenyl) ethane, 4,4′-[1-[4-[1-(4-hydroxyphenyl)-1-methylethyl]phenyl]ethylidene]bisphenol, α,α′,α″-tris(4-hydroxyphenyl)-1,3,5-triisopropylbenzene, 1-[α-methyl-α-(4′-hydroxyphenyl)ethyl]-4-[α′,α′-bis(4″-hydroxyphenyl)ethyl]benz ene, phloroglucin, trimellitic acid, and isatinbis(o-cresol).

An alkaline aqueous solution containing sodium hydroxide, potassium hydroxide, or the like can be preferably used as the alkaline aqueous solution, and in normal cases, a solution having a concentration of from 1 mass % to 15 mass % is preferably used. The content of the dihydric phenol in the alkaline aqueous solution is typically selected from the range of from 0.5 mass % to 20 mass %. Further, the usage amount of the organic solvent is desirably selected so that a volume ratio between an organic phase and an aqueous phase may be from 5/1 to 1/7, preferably from 2/1 to 1/4. A reaction temperature is selected from the range of typically from 0° C. to 70° C., preferably from 5° C. to 40° C. A chloroformate end group concentration in the polycarbonate oligomer to be obtained is typically from 0.6 mol/L to 0.9 mol/L, and in this case, a polycarbonate oligomer having a weight-average molecular weight of less than 5,000 can be obtained.

In the polycarbonate oligomer production process, a compound, such as p-t-butylphenol, p-cumylphenol or phenol, can be used as an end terminator (molecular weight modifier) as required. And also, as required for accelerating the reaction, the same catalyst as that used in a step (a-1) to be described later can be used.

The oligomer can be produced continuously or in a batch manner by using a tank-type reactor as a reactor. A method involving continuously producing the oligomer with a tubular reactor is also a preferred production method.

A reaction liquid obtained by the method described above is obtained in the state of an emulsion containing an organic phase containing the polycarbonate oligomer having a weight-average molecular weight of less than 5,000 and an aqueous phase containing impurities, such as sodium chloride, and the reaction liquid in the emulsion state is subjected to, for example, a settled separation to be separated into the organic phase containing the polycarbonate oligomer and the aqueous phase. The separated organic phase containing the polycarbonate oligomer is used in a process for the production of the polycarbonate-polyorganosiloxane copolymer. A lower limit value for the weight-average molecular weight of the polycarbonate oligomer having a weight-average molecular weight of less than 5,000 is typically about 500.

### [Method of Producing Polycarbonate-Polyorganosiloxane Copolymer]

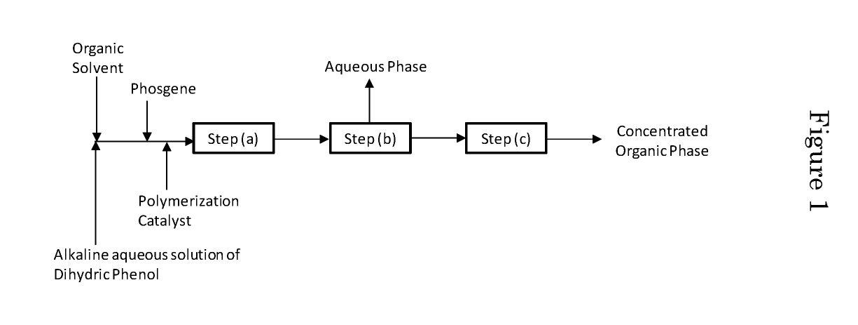

As illustrated in FIG. 1, the method of producing a polycarbonate-polyorganosiloxane copolymer (PC-POS) of the present invention comprises the step (a) to the step (c).

<Step (a)>

The step (a) is a step of obtaining the solution (polycondensation reaction liquid) containing the PC-POS through the use of the alkaline aqueous solution of the dihydric phenol, phosgene, the polyorganosiloxane, and the organic solvent. In the step (a), polymerization can be performed in the presence of a polymerization catalyst and a molecular weight modifier as required.

Though it is not particular limited to, the step (a) is preferably formed of a step (a-1) and a step (a-2), from the viewpoint of improving the transparency of the PC-POS.

The step (a-1) is a step of causing part of the end groups of the polycarbonate oligomer having a weight-average molecular weight of less than 5,000 described above to react with the polyorganosiloxane to produce the polycarbonate oligomer that has reacted with the polyorganosiloxane. No polycondensation reaction is performed in the step (a-1).

The step (a-2) is a step of introducing a reaction liquid containing the polycarbonate oligomer, obtained in the step (a-1), that has reacted with the polyorganosiloxane, the alkaline aqueous solution of the dihydric phenol, and a caustic alkali to subject the polycarbonate oligomer that has reacted with the polyorganosiloxane and the dihydric phenol to polycondensation, and is a step of setting the viscosity-average molecular weight of the PC-POS to be obtained to a target value.

<Raw Materials to be Used in Step (a-1)>

### (i) Polycarbonate Oligomer

As described above, the polycarbonate oligomer having a weight-average molecular weight of less than 5,000 is used as the organic phase containing the polycarbonate oligomer having a weight-average molecular weight of less than 5,000. Methylene chloride is preferably used as the organic solvent of the organic phase.

### (ii) Polyorganosiloxane

Examples of the polyorganosiloxane may include those described above. However, when the polyorganosiloxane is introduced into the step (a-1), the polyorganosiloxane is preferably used after having been dissolved in an organic solvent, preferably methylene chloride because the polyorganosiloxane has low compatibility with the polycarbonate oligomer. When a solution of the polyorganosiloxane in the organic solvent having a specific concentration is prepared in advance, an introduction amount per unit time at the time of continuous introduction of the polyorganosiloxane becomes constant, and hence continuous production in the step (a-1) becomes preferred. In normal cases, the polyorganosiloxane is desirably used at a concentration in the range of from 10 mass % to 30 mass %.

(iii) Caustic Alkali

In the step (a-1), in order that the reaction between the polycarbonate oligomer and the polyorganosiloxane may be performed, a reaction condition needs to be kept alkaline (caustic alkali concentration: 0.05 N to 0.7 N). A caustic alkali to be used is preferably sodium hydroxide or potassium hydroxide. The caustic alkali is preferably introduced as an aqueous solution.

### (iv) Other Raw Material

A known catalyst to be used at the time of the interfacial polycondensation of a polycarbonate resin can be used for accelerating the reaction in the step (a-1). A phase transfer catalyst, such as a tertiary amine or a salt thereof, a quaternary ammonium salt, or a quaternary phosphonium salt, may be preferably used as the catalyst. Examples of the tertiary amine include triethylamine, tributylamine, N,N-dimethylcyclohexylamine, pyridine, and dimethylaniline, and examples of the tertiary amine salt include hydrochlorides and bromates of those tertiary amines. Examples of the quaternary ammonium salt include trimethylbenzylammonium chloride, triethylbenzylammonium chloride, tributylbenzylammonium chloride, trioctylmethylammonium chloride, tetrabutylammonium chloride, and tetrabutylammonium bromide, and examples of the quaternary phosphonium salt include tetrabutylphosphonium chloride and tetrabutylphosphonium bromide. One of those catalysts may be used alone, or two or more thereof may be used in combination. Among the catalysts, a tertiary amine is preferred and triethylamine is particularly preferred. Any such catalyst can be introduced as it is, or after having been dissolved in an organic solvent or water when the catalyst is in a liquid state. In addition, a catalyst in a solid state can be introduced after having been dissolved in an organic solvent or water.

<Reactor to be Used in Step (a-1) and Reaction Condition>

The oligomer reacted with the polyorganosiloxane can be produced continuously or in a batch manner by using a line mixer, a static mixer, an orifice mixer, a stirring tank, or the like as a reactor to be used in the step (a-1). Those reactors may be arbitrarily combined to be used as a plurality of reactors. In addition, among those reactors, a line mixer is particularly preferably used because the oligomer reacted with the polyorganosiloxane can be continuously produced and hence the reaction can be efficiently advanced.

<Raw Materials to be Used in Step (a-2)>
(i) Reaction Liquid Containing Polycarbonate Oligomer that has Reacted with Polyorganosiloxane

The reaction liquid (PC-POS oligomer reaction liquid) containing the polycarbonate oligomer that has reacted with the polyorganosiloxane obtained in the step (a-1) described above is used.

### (ii) Alkaline Aqueous Solution of Dihydric Phenol

The alkaline aqueous solution of the dihydric phenol to be used in the step (a-2) is used for increasing the molecular weight of the polycarbonate oligomer that has reacted with the polyorganosiloxane obtained in the step (a-1) through a polycondensation reaction therewith.

The dihydric phenol to be used is the dihydric phenol represented by the general formula (1) to be used at the time of the production of the polycarbonate oligomer, and a particularly preferred dihydric phenol represented by the general formula (1) may be, for example, bisphenol A.

An alkaline aqueous solution to be used at the time of the production of the polycarbonate oligomer, which contains sodium hydroxide, potassium hydroxide, or the like, can be preferably used as the alkaline aqueous solution. With regard to the concentration of a caustic alkali, such as sodium hydroxide or potassium hydroxide, in the alkaline aqueous solution, a solution having a concentration of from 1 mass % to 15 mass % is similarly preferably used. The content of the dihydric phenol in the alkaline aqueous solution is similarly selected from the range of from 0.5 mass % to 20 mass %.

(iii) Caustic Alkali

In the step (a-2), an increase in molecular weight can be performed by causing the alkaline aqueous solution of the dihydric phenol and the polycarbonate oligomer that has reacted with the polyorganosiloxane to react with each other (interfacial polycondensation reaction). In the reaction, the dihydric phenol becomes an alkali metal salt in the alkaline aqueous solution of the dihydric phenol, and the alkali metal salt of the dihydric phenol and a chloroformate group of the polycarbonate oligomer that has reacted with the polyorganosiloxane, the oligomer being dissolved in the organic solvent, are subjected to a desalting reaction at an interface between an organic phase and an aqueous phase to cause the polycondensation, and hence the increase in molecular weight is achieved. The interfacial polycondensation reaction advances under an alkaline condition. Accordingly, the reaction needs to be performed by adding the caustic alkali, such as sodium hydroxide or potassium hydroxide, for accelerating the reaction.

### (iv) Other Raw Material

In the step (a-2), the solution (polycondensation reaction liquid) containing the PC-POS after the completion of the polycondensation reaction is removed. An end terminator selected from p-t-butylphenol, p-cumylphenol, and phenol is preferably used as an end terminator (molecular weight modifier) for adjusting the molecular weight of the PC-POS after the completion of the reaction in the step (a-2).

The same catalyst as that used in the step (a-1) can be used for accelerating the polycondensation reaction, and a preferred aspect thereof is also the same.

<Reactor to be Used in Step (a-2) and Reaction Condition>

In the step (a-2), the reaction can be completed with only one reactor depending on its ability. However, a plurality of reactors, such as a second reactor subsequent thereto and a third reactor, can be further built as required. A stirring tank, a tower-type stirring tank with a vertical multistage impeller, a stationary tank, a static mixer, a line mixer, an orifice mixer, piping, or the like can be used as a reactor to be used in the step (a-2). Those reactors may be arbitrarily combined to be used as a plurality of reactors.

A method of producing the solution (polycondensation reaction liquid) containing the PC-POS in the step (a) can be performed continuously or in a batch manner. When the solution is produced in a batch manner, the following is desirably performed. First, in the reactor to be used in the step (a-1), the polycarbonate oligomer having a weight-average molecular weight of less than 5,000, the polyorganosiloxane, the catalyst (e.g., TEA), and the caustic alkali are used to perform the reaction between the polycarbonate oligomer and the polyorganosiloxane so that the polycarbonate oligomer that has reacted with the polyorganosiloxane may be produced. Next, the caustic alkali and the dihydric phenol are loaded into the same reactor and the condition is set for the step (a-2) (specifically a caustic alkali concentration of from 0.05 N to 0.7 N). In other words, it is desirable that the conditions for both the step (a-1) and the step (a-2) be set in order by regulating reaction conditions while using the same reactor.

A temperature in the step (a-2) is preferably set to from 20° C. to 35° C. In particular, when the temperature in the step (a-2) is more than 35° C., the following risk occurs: the end hydroxyl group fraction of a molded article increases to increase the YI value of the molded article. Accordingly, the temperature is preferably set to 35° C. or less.

<Step (b)>

The step (b) is a step of continuously or intermittently draining the solution (polycondensation reaction liquid) containing the PC-POS from the reactor of the step (a), followed by the separation of the drained solution into the aqueous phase and the organic phase.

The polycondensation reaction liquid obtained in the step (a) is in an emulsion state, and the emulsion needs to be separated into the organic phase containing the PC-POS and the aqueous phase. To that end, an inert organic solvent, such as methylene chloride, is added to the polycondensation reaction liquid obtained in the step (a) to appropriately dilute the liquid, and then the diluted liquid is separated into the aqueous phase and the organic phase containing the PC-POS by an operation, such as settled separation or centrifugal separation.

The organic phase containing the PC-POS thus separated is subjected to a washing treatment with, for example, an alkaline aqueous solution, an acidic aqueous solution, and pure water in order that a residual monomer, a catalyst, an alkaline substance, and the like serving as impurities may be removed. The washed mixture is separated into an organic phase containing a purified PC-POS and an aqueous phase with a centrifugal separator or a settling tank.

When the organic phase obtained in the step (b) is a methylene chloride solution containing the PC-POS, the polymer concentration of the methylene chloride solution containing the PC-POS is preferably from 10 mass % to 30 mass %, more preferably from 11 mass % to 25 mass %, still more preferably from 12 mass % to 20 mass %.

<Step (c)>

The step (c) is a step of concentrating the organic phase containing the PC-POS obtained in the step (b) to remove the organic solvent. In the step (c), the organic phase containing the PC-POS is heated to from 40° C. to 150° C. under a pressure of from 0.2 MPa to 2.0 MPa to be concentrated. A concentrator to be used when the concentration is performed is not particularly limited, and any concentrator can be used as long as the concentrator includes heating and decompression devices. The concentrator may be specifically, for example, an instrument, such as a flash drum.

In order that the organic phase containing the PC-POS may be efficiently powdered or granulated with a kneader, a granulator of powder bed, a granulator using hot water, or the like, in the step (c), the organic phase needs to be concentrated by heating to a boiling region. The organic phase containing the PC-POS that has undergone the concentrating step is concentrated so as to have a polymer concentration of preferably from 20 mass % to 50 mass %, more preferably from 25 mass % to 45 mass %.

In the case where the chain length of the PC-POS in the organic phase containing the PC-POS obtained in the step (b) is as short as from about 25 to about 55, when the organic phase is heated to the boiling region in the step (c), the organic phase causes peculiar bubbling owing to the evaporation of the organic solvent, and hence the heat transfer performance of a heat exchanger rapidly deteriorates to reduce productivity. In view of this problem, in the case where the chain length of the PC-POS in the organic phase containing the PC-POS obtained in the step (b) is as short as from about 25 to about 55, the viscosity of the organic phase containing the PC-POS at 35° C. needs to be adjusted to 70 cP or less before heating the organic phase to the boiling region with the heat exchanger to concentrate the organic phase, in order that the removal of the produced bubbles may be advanced. When the viscosity of the organic phase containing the PC-POS at 35° C. is more than 70 cP, the produced bubbles do not disappear, then in the following heating, the heat transfer performance of the heat exchanger becomes unsatisfactory. From such viewpoint, the viscosity of the organic phase containing the PC-POS at 35° C. is preferably 65 cP or less, more preferably 60 cP or less, still more preferably 55 cP or less.

The viscosity of the organic phase containing the PC-POS at 35° C. can be adjusted by, for example, adjusting the amount of the inert organic solvent to be used for dilution in the step (b), such as methylene chloride. However, a method for the adjustment is not limited thereto as long as the viscosity can be adjusted.

[Steps after Reaction]

### <Powdering Step, Granulating Step, and Drying Step>

The concentrated organic phase containing the PC-POS obtained in the step (c) is powdered or granulated by a known powdering step or granulation method using, for example, a kneader, a granulator of powder bed, or a granulator using hot water. The resultant powdered product or granulated product contains 10 mass % to 50 mass % of the used organic solvent, such as methylene chloride, and hence the content of the residual organic solvent is desirably set to 1,000 ppm or less by further performing heat drying, drying under reduced pressure, or the like.

In the production method of the present invention, in the concentrating step, the air bubbles produced by the evaporation of the organic solvent and a reduction in heat transfer performance of the heat exchanger can be prevented, and hence a reduction in production amount is prevented. Accordingly, a method of producing a PC-POS, the method having satisfactory production efficiency, can be provided.

A polyorganosiloxane content in the PC-POS obtained by the method of producing a polycarbonate-polyorganosiloxane copolymer of the present invention is preferably from 1.0 mass % to 50 mass %, more preferably from 1 mass % to 20 mass %, still more preferably from 3 mass % to 12 mass % from the viewpoint of, for example, balance among a flame retardance, an impact resistance, and economical efficiency.

The viscosity-average molecular weight of the PC-POS obtained by the method of producing a polycarbonate-polyorganosiloxane copolymer of the present invention is preferably from 10,000 to 30,000, and is more preferably from 15,000 to 20,000 from the viewpoint of handling.

The viscosity-average molecular weight (Mv) of the PC-POS is calculated from the following equation by determining a limiting viscosity [η] through the measurement of the viscosity of a methylene chloride solution at 20° C. with an Ubbelohde-type viscometer.

[η]=1.23×10⁻⁵×Mv^{0.83}

The PC-POS obtained by the method of producing a polycarbonate-polyorganosiloxane copolymer of the present invention can be mixed with a polycarbonate resin except the PC-POS at an arbitrary ratio to provide a polycarbonate resin composition containing the PC-POS.

The polycarbonate resin to be mixed is not particularly limited, and various known polycarbonate resins except the PC-POS can each be used.

An additive, such as an antioxidant, a UV absorber, a flame retardant, a release agent, an inorganic filler (e.g., a glass fiber, talc, titanium oxide, or mica), a colorant, or a light-diffusing agent, can be used in the PC-POS or the polycarbonate resin composition containing the PC-POS as required in accordance with characteristics required in a target application. The PC-POS or the resin composition containing the PC-POS can be molded into a molded body by any one of various molding methods, such as injection molding, injection compression molding, extrusion molding, and blow molding.

The molded body obtained by molding the PC-POS or the resin composition containing the PC-POS is expected to be widely utilized in various fields, such as electrical and electronic fields, and an automobile field. In particular, the molded body can be utilized as, for example, a material for the casing of a cellular phone, a mobile personal computer, a digital camera, a video camera, an electric power tool, or the like, or a material for other articles for daily use.

### EXAMPLES

The present invention is hereinafter described more detail by way of Examples. The present invention is not limited by these examples.

### Example 1

<Step (a)>

To 5.6 mass % aqueous sodium hydroxide, sodium dithionite was added in an amount of 2,000 ppm by mass relative to bisphenol A to be dissolved later, and bisphenol A was then dissolved therein so that the concentration of bisphenol A became 13.5 mass %, to thereby prepare a solution of bisphenol A in aqueous sodium hydroxide.

The solution of bisphenol A in aqueous sodium hydroxide, methylene chloride, and phosgene were continuously passed through a tubular reactor having an inner diameter of 6 mm and a tube length of 30 m at flow rates of 40 L/hr, 15 L/hr, and 4.0 kg/hr, respectively. The tubular reactor had a jacket portion, and cooling water was passed through the jacket to keep the reaction liquid at a temperature of 40° C. or less.

The reaction liquid that had exited the tubular reactor was continuously introduced into a baffled tank-type reactor having an internal volume of 40 L and provided with a sweptback blade, and then, 2.8 L/hr of the solution of bisphenol A in aqueous sodium hydroxide, 0.07 L/hr of 25 mass % aqueous sodium hydroxide, 17 L/hr of water, and 0.64 L/hr of a 1 mass % triethylamine aqueous solution were further added to the reactor to perform a reaction. The reaction liquid overflown from the tank-type reactor was continuously taken out and left to stand still to separate and remove an aqueous phase, and a methylene chloride phase was then collected.

The concentration of the thus obtained polycarbonate oligomer solution (methylene chloride solution) was 318 g/L, and the concentration of a chloroformate group thereof was 0.75 mol/L. The polycarbonate oligomer had a weight-average molecular weight (Mw) of 1,190.

The weight-average molecular weight (Mw) was measured as a molecular weight (weight-average molecular weight: Mw) in terms of standard polystyrene by GPC (column: TOSOH TSK-GEL MULTIPORE HXL-M (two)+Shodex KF801 (one), temperature: 40° C., flow rate: 1.0 ml/min, detector: RI) with tetrahydrofuran (THF) as a developing solvent.

After 20 L/hr of the polycarbonate oligomer solution and 9.5 L/hr of methylene chloride had been mixed, a 20 mass % solution of an allylphenol terminal-modified polydimethylsiloxane (PDMS) having a number (n) of repetitions of a dimethylsiloxane unit of 40 in methylene chloride was added at 2.6 kg/hr to the mixture. After that, the materials were mixed well with a static mixer, and then the mixed liquid was cooled to from 19° C. to 22° C. with a heat exchanger.

0.5 kg/hr of a 1 mass % solution of triethylamine in methylene chloride was added to the cooled mixed liquid, and the contents were mixed. After that, 1.4 kg/hr of 8.0 mass % aqueous sodium hydroxide was added to the mixture. In the step (a-1), the resultant was supplied to T.K. Pipeline Homomixer 2SL Type (manufactured by PRIMIX Corporation) having an internal volume of 0.3 L, the homomixer provided with a turbine blade having a diameter of 43 mm and a turbine blade having a diameter of 48 mm, and the polycarbonate oligomer and the polydimethylsiloxane were caused to react with each other under stirring at a number of revolutions of 4,400 rpm. Thus, a reaction liquid (PC-PDMS oligomer reaction liquid) containing the polycarbonate oligomer that had reacted with the polydimethylsiloxane was obtained.

Subsequently, the resultant PC-PDMS oligomer reaction liquid was cooled to from 17° C. to 20° C. with a heat exchanger. After 10.2 kg/hr of a solution of bisphenol A in aqueous sodium hydroxide, 1.5 kg/hr of 15 mass % aqueous sodium hydroxide, and 1.3 kg/hr of an 8 mass % solution of p-t-butylphenol in methylene chloride had been added to the PC-PDMS oligomer reaction liquid after the cooling, in the step (a-2), the mixture was supplied to T.K. Pipeline Homomixer 2SL Type (manufactured by PRIMIX Corporation) [line mixer used as a first reactor in the step (a-2)] having an internal volume of 0.3 L, the homomixer provided with a turbine blade having a diameter of 43 mm and a turbine blade having a diameter of 48 mm, and a polymerization reaction was performed under stirring at a number of revolutions of 4,400 rpm.

Further, in order for the reaction to be completed, the resultant was supplied to a jacketed tower-type stirring tank having an internal volume of 50 L and having vertical arranged three paddle impeller [used as a second reactor in the step (a-2)], and polycondensation was performed. Thus, a solution (polycondensation reaction liquid) containing a polycarbonate-polydimethylsiloxane copolymer (PC-PDMS) was obtained. Cooling water at 15° C. was flowed through the jacket of the tower-type stirring tank, and the outlet temperature of the polycondensation reaction liquid was set to 35° C.

<Step (b)>

35 L of the polycondensation reaction liquid and 10 L of methylene chloride for dilution were loaded into a 50-L tank-type washing tank provided with a baffle board and a paddle-type stirring blade, and were stirred at 240 rpm for 10 minutes. After that, the mixture was left to stand still for 1 hour to be separated into an organic phase containing the PC-PDMS, and an aqueous phase containing excessive amounts of bisphenol A and sodium hydroxide. A moisture content in the organic phase 60 minutes after the still standing was measured with a Karl Fischer moisture meter. As a result, the moisture content was 2,000 ppm by mass.

The methylene chloride solution (organic phase) containing the PC-PDMS thus obtained was sequentially washed with 0.03 mol/L aqueous sodium hydroxide and 0.2 mol/L hydrochloric acid in amounts of 15 vol % each with respect to the solution. Next, the solution was repeatedly washed with pure water so that an electric conductivity in an aqueous phase after the washing became 0.1 mS/m or less.

The resultant PC-PDMS had a viscosity-average molecular weight of 17,600, and a polyorganosiloxane content in the PC-PDMS was 6.0 mass %. The polymer concentration of the methylene chloride solution containing the PC-PDMS after the washing was 14.3 mass %, and its viscosity measured with a tuning-fork vibration viscometer SV-10 manufactured by A & D Company, Limited was 50 cP at 35° C.

<Step (c)>

The methylene chloride solution containing the PC-PDMS after the washing was heated to a boiling region in an AEL-type multitubular heat exchanger having a heat transfer area of 6 m² under a pressure of 0.9 MPa with steam at 140° C. After that, the pressure was reduced to 0.2 MPa and the methylene chloride solution was degassed with a flash drum, followed by the concentration of the methylene chloride solution to a polymer concentration of 40 mass %. At this time, the amount of the methylene chloride solution that was able to be treated was 200 kg/hr (29 kg/hr in terms of the PC).

### Comparative Example 1

The production of a PC-PDMS was performed in the same manner as in Example 1 except that in the step (b) of Example 1, the amount of methylene chloride for dilution was changed to 4 L. The PC-PDMS obtained through the step (b) had a viscosity-average molecular weight of 17,600, and a polyorganosiloxane content in the PC-PDMS was 6.0 mass %. After washing, the polymer concentration of the methylene chloride solution containing the PC-PDMS was 16.5 mass %. At this time, the viscosity of the methylene chloride solution containing the PC-PDMS after the washing was measured with a tuning-fork vibration viscometer SV-10 manufactured by A & D Company, Limited. As a result, the viscosity was 80 cP at 35° C. In the step (c), the methylene chloride solution containing the PC-PDMS after the washing was heated to a boiling region in an AEL-type multitubular heat exchanger having a heat transfer area of 6 m² under a pressure of 0.9 MPa with steam at 140° C. After that, the pressure was reduced to 0.2 MPa and the methylene chloride solution was degassed with a flash drum, followed by the concentration of the methylene chloride solution to a polymer concentration of 40 mass %. At this time, the amount of the methylene chloride solution that was able to be treated was 130 kg/hr (21 kg/hr in terms of the PC).

### Comparative Example 2

The production of a PC-PDMS was performed in the same manner as in Example 1 except that in the step (b) of Example 1, the amount of methylene chloride for dilution was changed to 4 L. The PC-PDMS obtained through the step (b) had a viscosity-average molecular weight of 17,600, and a polyorganosiloxane content in the PC-PDMS was 6.0 mass %. After washing, the polymer concentration of the methylene chloride solution containing the PC-PDMS was 16.5 mass %. At this time, the viscosity of the methylene chloride solution containing the PC-PDMS after the washing was measured with a tuning-fork vibration viscometer SV-10 manufactured by A & D Company, Limited. As a result, the viscosity was 80 cP at 35° C. In the step (c), the methylene chloride solution of the PC-PDMS after the washing was heated to a boiling region in an AEL-type multitubular heat exchanger having a heat transfer area of 6 m² under a pressure of 0.9 MPa with steam at 150° C. After that, the pressure was reduced to 0.2 MPa and the methylene chloride solution was degassed with a flash drum, followed by the concentration of the methylene chloride solution to a polymer concentration of 40 mass %. At this time, the amount of the methylene chloride solution that was able to be treated was 145 kg/hr (24 kg/hr in terms of the PC).

In Comparative Example 1, the treatment amount became smaller than that of Example 1 owing to the increase in viscosity of the solution. In Comparative Example 2, the treatment amount could not be increased to that of Example 1 even when the temperature of the steam was made higher than that of Example 1.

### INDUSTRIAL APPLICABILITY

The method of producing a polycarbonate-polyorganosiloxane copolymer of the present invention can efficiently provide a polycarbonate-polyorganosiloxane copolymer because the method can prevent a reduction in heat transfer performance of a heat exchanger, and hence prevents a reduction in production amount.

1. A method of producing a polycarbonate-polyorganosiloxane copolymer, comprising:
a step (a) of obtaining a solution containing a polycarbonate-polyorganosiloxane copolymer through use of an alkaline aqueous solution of a dihydric phenol, phosgene, a polyorganosiloxane, and an organic solvent;
a step (b) of separating the solution containing the polycarbonate-polyorganosiloxane copolymer obtained in the step (a) into an aqueous phase and an organic phase to provide the organic phase containing the polycarbonate-polyorganosiloxane copolymer; and
a step (c) of concentrating the organic phase containing the polycarbonate-polyorganosiloxane copolymer obtained in the step (b) to remove the organic solvent,
before heating the organic phase to a boiling region in the step (c), a viscosity of the organic phase being adjusted to 70 cP or less at 35° C.,
the polycarbonate-polyorganosiloxane copolymer obtained by the steps (a) to (c) comprising a polycarbonate-polyorganosiloxane copolymer containing a polycarbonate block (A) having a repeating unit represented by the following general formula (I) and a polyorganosiloxane block (B) having a repeating unit represented by the following general formula (II): 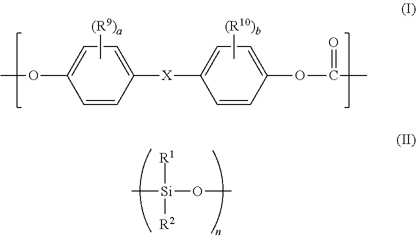
wherein R⁹ and R¹⁰ each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, a and b each independently represent an integer of from 0 to 4, le and R² each independently represent a hydrogen atom, a halogen atom, an alkyl group having 1 to 6 carbon atoms, an alkoxy group having 1 to 6 carbon atoms, or an aryl group having 6 to 12 carbon atoms, and an average number n of repetitions is from 25 to 55, and represents a total number of siloxane repeating units in the polyorganosiloxane block.

2. The method of producing a polycarbonate-polyorganosiloxane copolymer according to claim 1, wherein the dihydric phenol comprises a dihydric phenol represented by the following general formula (1): 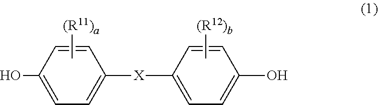
wherein R¹¹ and R¹² each independently represent an alkyl group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, —S—, —SO—, —SO₂—, —O—, or —CO—, and a and b each independently represent an integer of from 0 to 4.

3. The method of producing a polycarbonate-polyorganosiloxane copolymer according to claim 1, wherein the polyorganosiloxane comprises a polyorganosiloxane represented by at least one selected from the following general formulae (2), (3), and (4): 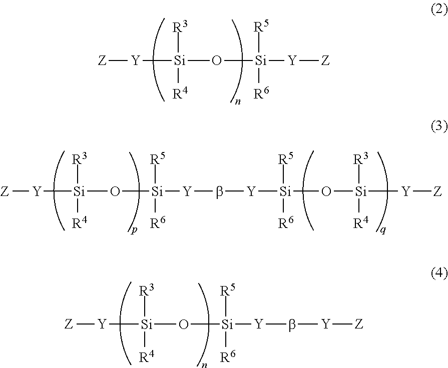
wherein R³ to R⁶ each independently represent a hydrogen atom, a halogen atom, an alkyl group having 1 to 6 carbon atoms, an alkoxy group having 1 to 6 carbon atoms, or an aryl group having 6 to 12 carbon atoms, and a plurality of R³, R⁴, R⁵ and/or R⁶ may be identical to or different from each other, Y represents —R⁷O—, —R⁷COO—, —R⁷NH—, —R⁷NR⁸—, —COO—, —S—, —R⁷COO—R⁹—O—, or —R⁷O—R¹⁰—O—, and a plurality of Y may be identical to or different from each other, the R⁷ represents a single bond, a linear, branched, or cyclic alkylene group, an aryl-substituted alkylene group, a substituted or unsubstituted arylene group, or a diarylene group, R⁸ represents an alkyl group, an alkenyl group, an aryl group, or an aralkyl group, R⁹ represents a diarylene group, R¹⁰ represents a linear, branched, or cyclic alkylene group, or a diarylene group, Z represents a hydrogen atom or a halogen atom, and a plurality of Z may be identical to or different from each other, β represents a divalent group derived from a diisocyanate compound, or a divalent group derived from a dicarboxylic acid or a halide of a dicarboxylic acid, p and q each represent an integer of 1 or more, and a sum of p and q is from 25 to 55, and n represents an average number of repetitions of from 25 to 55.

4. The method of producing a polycarbonate-polyorganosiloxane copolymer according to claim 1, wherein the dihydric phenol comprises bisphenol A.

5. The method of producing a polycarbonate-polyorganosiloxane copolymer according to claim 1, wherein the organic phase comprises a methylene chloride solution containing the polycarbonate-polyorganosiloxane copolymer.

6. The method of producing a polycarbonate-polyorganosiloxane copolymer according to claim 5, wherein the methylene chloride solution containing the polycarbonate-polyorganosiloxane copolymer has a polymer concentration of from 10 mass % to 30 mass %.

7. The method of producing a polycarbonate-polyorganosiloxane copolymer according to claim 1, wherein concentrating the organic phase is performed by heating the organic phase to from 40° C. to 150° C. under a pressure of from 0.2 MPa to 2.0 MPa.

8. The method of producing a polycarbonate-polyorganosiloxane copolymer according to claim 1, wherein a polyorganosiloxane content in the polycarbonate-polyorganosiloxane copolymer is from 1 mass % to 50 mass %.

9. The method of producing a polycarbonate-polyorganosiloxane copolymer according to claim 1, wherein the polycarbonate-polyorganosiloxane copolymer has a viscosity-average molecular weight of from 10,000 to 30,000.
